(19) United States
(12) Patent Application Publication
(10) Pub. No.: US 2015/0090644 A1
(43) Pub. Date: Apr. 2, 2015

(54) DEVICE FOR REMOVING CLARIFIED WATER

(71) Applicant: Veolia Water Solutions & Technologies Support, Saint-Maurice Cedex (FR)

(72) Inventor: Patrick Exposito, Montauban (FR)

(73) Assignee: Veolia Water Solutions & Technologies Support, Saint-Maurice Cedex (FR)

(21) Appl. No.: 14/373,079

(22) PCT Filed: Jan. 21, 2013
(86) PCT No.: PCT/EP2013/051064

§ 371 Date: Nov. 17, 2014

(30) Foreign Application Priority Data
Jan. 20, 2012 (FR) 1250586

(51) Int. Cl. B01D 21/24

(52) U.S. Cl. CPC B01D 21/2444
USPC 210/122; 210/242.1

(57) ABSTRACT

A device is provided for removing clarified water from a basin. The device includes a water receiving unit associated with a float. The float and water receiving unit is disposed over a pipe assembly. The float and water receiving unit is moveable up and down and, in the process, the telescoping pipe assembly retracts and expands. Water received by the water receiving unit is directed through the pipe assembly to an outlet.

This application is a U.S. National Stage Application of PCT Application No. PCT/EP2013/051064, with an international filing date of 21 Jan. 2013. Applicant claims priority based on French Patent Application No. 1250586 filed 20 Jan. 2012. The subject matter of these applications is incorporated herein.

### 1. FIELD OF THE INVENTION

The invention pertains to the designing and making of plants for treating water in order to purify it or make it potable.

More specifically, the invention pertains to devices, commonly called weirs or weir assemblies, which equip water treatment basins enabling the surface collection of clarified water in order to discharge it from the basins in question.

### 2. PRIOR ART

Such weirs are used especially in wastewater treatment plants implementing the technique known as the SBR (sequencing batch reactor) technique. This technique consists in bringing a quantity of water into contact with activated sludges in a basin, performing aeration and settling sequences in alternation and discharging surface clarified water following the settling phase. During this last phase, the clarified water present on the surface has to be collected in order to be discharged from the basin, thus causing a drop in the level of water in the basin. This operation of discharging can be done by pumping, by means of a pump that is held by floats on the surface of the water. However, for energy-saving purposes it is preferred, rather than this technique, to use the one in which the clarified water is discharged from the basin by gravitational flow, using weirs made to remain on the surface of the water by means of floats.

In order to carry out this operation of discharging clarified water gravitationally, there are known weirs provided with a float enabling them to stay on the surface of the water of the basin and a unit for removing water into which the clarified water falls and is then again taken by gravitational collecting and discharging means.

Several types of floating weirs are thus known.

Some weirs consist of a simple funnel placed in a float that floats freely on the surface of the water, i.e. without any means for guiding the float, the funnel being connected to a discharging pipe.

Other more elaborate weirs include a tilting float. These devices include a float provided with means for removing water and a lever arm linked at one of its ends to this float and connected by the other of its ends to a water discharging system.

Yet other devices include a means for guiding the float in vertical translation, provided with a unit for removing water, the means in question including two lateral guide bars mounted in parallel to the axis of vertical movement of the floating weir, provided on either side of the float and fixed to the wall of the basin equipped with such a device. Such a sliding floating weir is described especially in the French patent application FR-A-2873724.

Simple floating weirs without any guiding system have limited capacities in terms of treatment flow rate. Furthermore, since their hydraulic behavior is entirely random as there is no guidance for the float, they can be used only in a restricted number of cases, for example for oil skimming or the discharging of an overspill from a treatment basin of a station.

The designing of the tilting weirs implies that their position relative to the wall of the basin varies as a function of the height of water in the basin. Their hydraulic behavior is therefore variable according to this height of water. This variable hydraulic behavior may give rise to the removal of “floating material”, i.e. supernatant matter present on the surface of the water and/or that of “subnatants”, i.e. matter in suspension present just beneath the surface of the water. Such removal is of course to be avoided in order to maintain the quality of the clarified water removed.

Furthermore, the arm of the lever equipping such tilting weirs picks up the hydraulic forces absorbed by the surface of the float. Since this arm moves with the surface level of the water in the basin, the associated moment increases when the level of the water falls in it. Since the energy produced by the movement of the water in the basin is excessive, such tilting weirs are not recommended since their installation could then lead to their mechanical deterioration.

Weirs sliding on two lateral guiding arms for their part have the drawback of requiring an on-site assembly of the guide bars that must be a painstaking task since the axis of positioning of these guide bars is independent of the sliding axis of the float.

Furthermore, the sliding of the float along these lateral bars causes hyperstatism which can lead to the jamming of the float and therefore, in practice, to putting the weir out of service, and hence to necessitating on-site action to restore a sliding of the float along the guide bars. Such action leads to an increase in the costs of operation.

Finally, since such sliding weirs are fixed to the wall of the basin that they equip, the position of their float relative to this wall can no longer be modified after they are put into water. Now, when the weir is put into service, it can turn out to be the case that a better orientation of the float in the basin would have optimized the working of this weir.

Whatever the nature of the floating weir used, the quality of the clarified water effectively removed at the weir must be monitored through regular measurements of its different physical/chemical parameters. In practice, this is done by the use of probes, which an operator brings to the float by means of long poles. This operation which may prove to be dangerous, especially if the level of water in the basin is low, can be complicated if the energy dispersed on the surface of the basin is high. Furthermore, a removal technique of this kind does not provide for high reproducibility of the measurements made since the removal operations cannot always be done at the same distance from the float.

### 3. GOALS OF THE INVENTION

The invention is aimed especially at overcoming these drawbacks of the prior art.

More specifically, it is a goal of the invention to provide a device for removing clarified water provided with means for guiding in vertical translation that involve practically no risk of jamming of the float.

It is also an object of the invention, in at least one embodiment, to provide a device of this kind that greatly restricts the removal of floating material or subnatants.

It is again a goal of the invention, in at least one embodiment, to provide a device of this kind, the orientation of which, relative to the wall of the basin, can be adjusted after it has been put into water.

It is another goal of the invention, in at least one embodiment, to propose a device of this kind provided with means that can be used to optimize the operation for measuring the physical/chemical parameters of the removed clarified water by probes.

It is again a goal of the invention, in at least one embodiment, to propose a device of this kind that can be sized in order to treat very high flow rates of water.

It is again a goal of the invention, in at least one embodiment, to propose a device of this kind, for which the time of mounting on the basin that it equips is reduced as compared with the time needed for mounting the devices of the prior art.

It is again a goal of the invention, in at least one embodiment, to propose a device of this kind that can be transported in occupying, for equivalent processing capacities, a smaller volume than the devices of the prior art.

### 4. SUMMARY OF THE INVENTION

These different goals as well as others that shall appear here below are achieved through the invention, which pertains to a device for removing clarified water that is to equip a basin, said device comprising:
at least one float mobile in vertical translation provided with at least one water removing unit;
means for collecting and discharging the removed water;
means for guiding said mobile float in vertical translation;
means of support and fixed attachment to said basin;
characterized in that said device comprises a vertical central guide bar disposed along its central axis of gravity, said guide bar passing through said float and extending into said means for collecting and discharging.

The invention therefore relies on a wholly original approach in which it is planned to make the float slide only on a vertical central guide bar provided on the axis of gravity of the device. According to such a configuration, the guiding axis of the float and its axis of movement coincide with each other. This configuration eliminates the problems of hyperstatism observed with floatation devices in which the float is guided by two lateral guide bars and in which the two guiding axes are therefore distinct from the axis of movement of the float, giving rise to problems of jamming of the float. According to the invention, since the guide bar of the device is planned along the central axis of gravity of the device, it is not subjected to any forces during operation. The forces to which the device is subjected are entirely picked up by the means for support and fixed attachment to the basin. There is therefore almost no risk of the float getting jammed on the guide bar.

Consequently, through the invention, the risks of removing matter that is floating on the surface of the water or subnatant matter close to the surface are very low for the central guide bar of the float ensures that the float, and therefore the means for removing water that equip it, constantly follow the level of water in the basin, which was not always the case in the prior art according to which the guidance was provided by two lateral guide bars.

Preferably, said means for collecting and discharging of the device according to the invention are telescopic and comprise an upper tube connected to said water removing unit and a lower tube to be connected to a conduit for discharging water.

The assembly constituted by the means for support and fixed attachment to the basin, the guide bar and the lower tube of the collecting and discharging means then constitute a fixed assembly fixedly attached to the basin while the float equipped with the means for collecting water and the upper tube of said means for collecting and discharging constitute an assembly that is mobile in vertical translation. The different parts constituting the device can advantageously be pre-assembled in factory so that they can be easily and conveniently brought to the site and swiftly mounted in the basin. Furthermore, in-factory assembly gives this assembly an excellent degree of precision. Tests can be made on the device before it is mounted in the basin. Such an in-factory pre-assembling of the device according to the invention is of great interest during the first installation of the device. Furthermore, since all the parts of the device can be dismantled, the maintenance of the device is facilitated.

According to a preferred aspect of the invention, said means of support and fixed attachment to the basin include a bracket mount, the horizontal part of which is connected to said guide bar and the vertical part of which is intended to be fixed to the wall of said basin. This configuration makes it possible to efficiently pick up the forces exerted on the device by the bracket mount, which can be firmly fixed to the basin by means of appropriate attachment means.

It will be noted that the horizontal part of the bracket mount could be directly linked to the guide bar or, as explained here below in greater detail, linked to it by means of one or more mechanical elements.

According to a preferred aspect, said means of support and fixed attachment include at least one linking bar connecting said vertical part of said bracket mount to said lower tube of said means for collecting and discharging. A linking bar of this kind makes it possible to strengthen these support and fixed attachment means.

Again preferably, said water removing unit is constituted by a chamber provided beneath said float, said chamber having water inlet holes designed to be submerged and distributed throughout its rim or on a part of its rim. Since the holes are intended to be submerged, they make it possible to collect clarified water free of floating matter and charged with little or no subnatant matter.

Again preferably, said water inlet holes are surmounted by baffles. Such baffles make it possible to prevent the passage of certain floats.

According to an interesting variant of the invention, said chamber has a bottom part connected to said means for collecting and discharging and provided with gullies tilted towards said means for collecting and discharging. Through such a configuration, and especially through the tilted gullies, the clarified water entering the means for removing are directed towards the means for collecting with a minimum load loss. In practice, such gullies enable the acceleration of the water travelling into the chamber and the optimizing of its discharging time. The capacity of the device according to the invention is thereby optimized.

The float, as well as the unit for removing that equips it, could have different shapes. However, according to one particularly preferred variant, said float and said removing unit form an essentially parallelepiped-shaped assembly, said float being provided with a vertical central channel receiving said guide bar. It could thus be planned to provide water inlet holes of the water removing unit on one, two, three or four faces of this essentially parallelepiped-shaped unit, according to the configuration of the basin and as a function of the capacity to be given to the device according to the invention.

According to one particularly interesting variant of the invention, the device according to the invention comprises means for pivoting said float in a horizontal plane. Such means for pivoting are particularly interesting for adapting the device to different configurations of basins.

Also, according to one particularly practical variant of the invention, the device advantageously comprises a probe support mounted so as to be sliding on said horizontal bar and capable of being raised independently of said float. This probe support includes probes that collect a small quantity of water or measure at least one of its physical/chemical parameters. According to the invention, such a support is designed to rest on the float so that the probes that are associated with it are in contact with the surface water at the level of its collection by the removing unit. The guide bar of the device then serves as a guide unit also for the probes support. Thus the use, according to the prior art, of long poles to bring such probes to the level of the water removed by the weir is no longer necessary. The ergonomic aspects of this work are thereby improved. The raising of the probe support independently of the float can be done for example by a set of cables and a pulley. This raising can be done by hand but a motor could also be planned to carry it out.

When the device of the invention is intended for treating high flow rates of clarified water, its float can be formed by three parts, namely a central part and two lateral parts connected to said central part and planned to be on either of its sides, each of said parts being equipped with a corresponding part of the clarified water, the device furthermore including two valves for controlling said water removing unit. Through such valves, it is possible to manage the quantity of water removed by the removing unit. Such valves provided downstream from the weir could replace the automatic valve that is provided downstream from the weir, on the water outlet conduit discharging water from the basin, and that commands the draining of the basin. These valves could allow the transit of variable quantities of water according to an instruction given to them by an automaton.

In order to facilitate the transportation of the mobile part of the device including the float and the removing unit, especially for its export, said lateral parts of said float are advantageously mounted so as to be pivoting on said central part. The amount of space required by the float can therefore be reduced by making the lateral parts pivot so that they get folded when they are transported. When it is mounted, the lateral parts can be raised to be aligned with the central part.

### 5. LIST OF FIGURES

The invention as well as different advantages shall be understood more easily by means of the following description of four different non-exhaustive embodiments given with reference to the appended drawings, of which:

FIG. 1 is a top view of a basin equipped with a device for removing clarified water according to the invention;

FIG. 2 is a perspective view of a first embodiment of a device according to the invention;

FIG. 3 is a front view of the float of the device shown in FIG. 2;

FIG. 4 is a side view of the float of the device shown in FIG. 2;

FIG. 5 is a top perspective view of the water removing unit of the float of the device shown in FIG. 2;

FIG. 6 is a top view of the removing unit shown in FIG. 3;

FIGS. 7 to 10 illustrate different steps of assembling the different elements constituting the device shown in FIG. 2;

FIG. 11 is a perspective view of a second embodiment of a device according to the invention including a pivoting float;

FIGS. 12 to 14 represent top views of the device of FIG. 11 illustrating three different positions of the float;

FIG. 15 shows a perspective view of a third embodiment of a device according to the invention including a probe support that is sliding and can be raised;

FIG. 16 is a perspective view of a fourth embodiment of a device according to the invention for treating high flow rates of water;

FIG. 17 is a front view of the mobile part of the device according to FIG. 16 in a position of transportation;

FIG. 18 shows the deployment of said mobile part of the device according to FIG. 16 before its installation.

### 6. DESCRIPTION OF EMBODIMENTS OF THE INVENTION

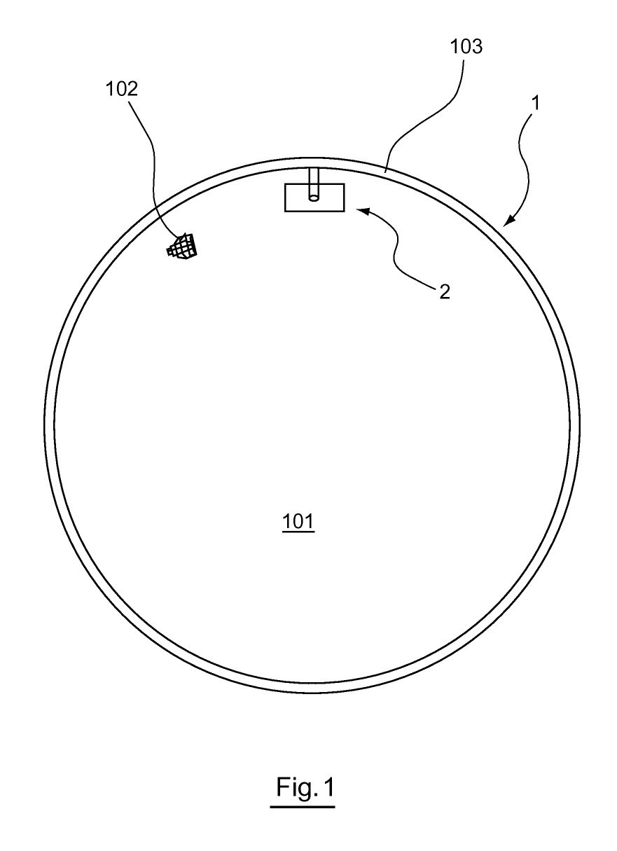

The four embodiments of the device for removing clarified water 2 are intended, referring to FIG. 1, to equip a basin 1 for treating water implemented according to the SBR (sequencing batch reactor) technique. However, the device according to the present invention is not limited to the equipment of basins implemented according to this technology but could also be installed in basins working according to another mode resulting however in clarified surface water that has to be discharged.

The basin 1 shown in FIG. 1 has a bottom 101 and a circular wall 103. It is equipped with aeration means 102 designed to be immersed in the basin for treating water so as to provide the activated sludges which develop therein with the oxygen needed to degrade the organic pollution contained in this water and therefore to purify it.

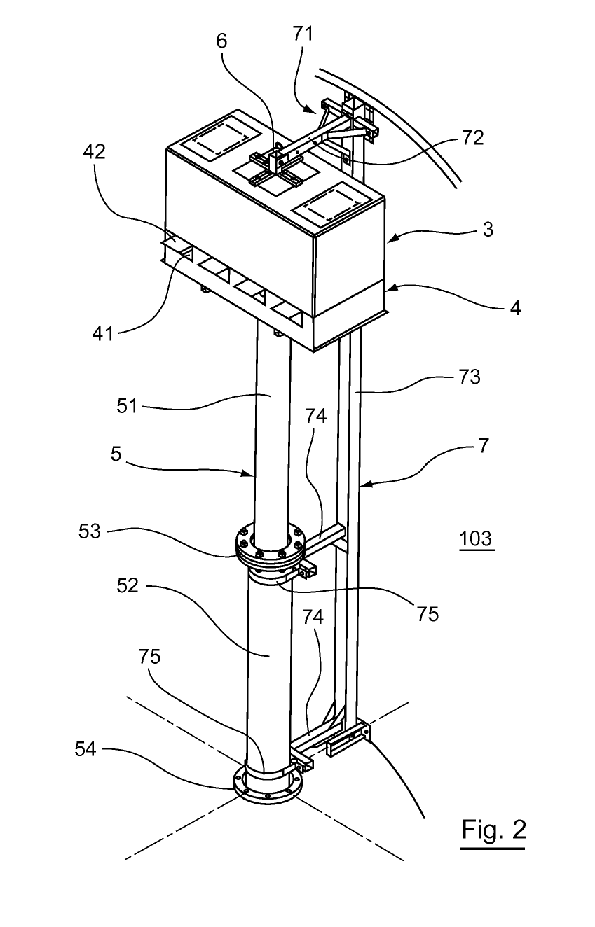

Referring to FIGS. 2 to 10, the first embodiment of the device for removing clarified water according to the invention shall now be described.

This first embodiment has a float 3 of an essentially parallelepiped shape including a block of material less dense than water such as polystyrene, provided in a protective casing made out of a physical or metallic material.

This float 3 is equipped at its base with a water removing unit 4 fixedly attached to the float 3, the assembly constituted by the float 3 and the removing unit 4 constituting an essentially parallelepiped-shaped assembly.

The water removing unit 4 is provided on its front with four water inlet holes 41 each surmounted by a baffle 42. Such baffles could be fixed or else mobile when it is sought to reduce the section of the holes 41 after they are put into operation.

The water removing unit 4 is connected to telescopic means for collecting removed water 5 constituted by an upper tube 51 and a lower tube 52. The lower tube 52 is intended to be connected by a connecting flange 54 to a water outlet conduit discharging the water removed by the weir out of the basin and provided with an automatic valve (not shown) permitting or not permitting the drainage of this weir. A tightly sealed connector 53 is provided between the two tubes 51, 52.

The device furthermore comprises means 7 for support and for fixed attachment to the wall 103 of the basin. These means for support and fixed attachment comprise a bracket mount 71 having a horizontal part 72 and a vertical part 73. Linking bars 74 are provided between the vertical bar 73 of the means of support and fixed attachment 7 to fixedly join the lower tube 52 of the means for collecting removed water 5 to the bracket mount 7 through collars 75.

Finally, the device described also comprises a guide bar 6 which, as shall be explained in greater detail with reference to the following figures, has an upper end fixed to the end of the horizontal part 72 of the bracket mount 71, the lower end of which is left free. In other embodiments, this lower end could be fixedly attached by soldering to the lower part of the tube 51.

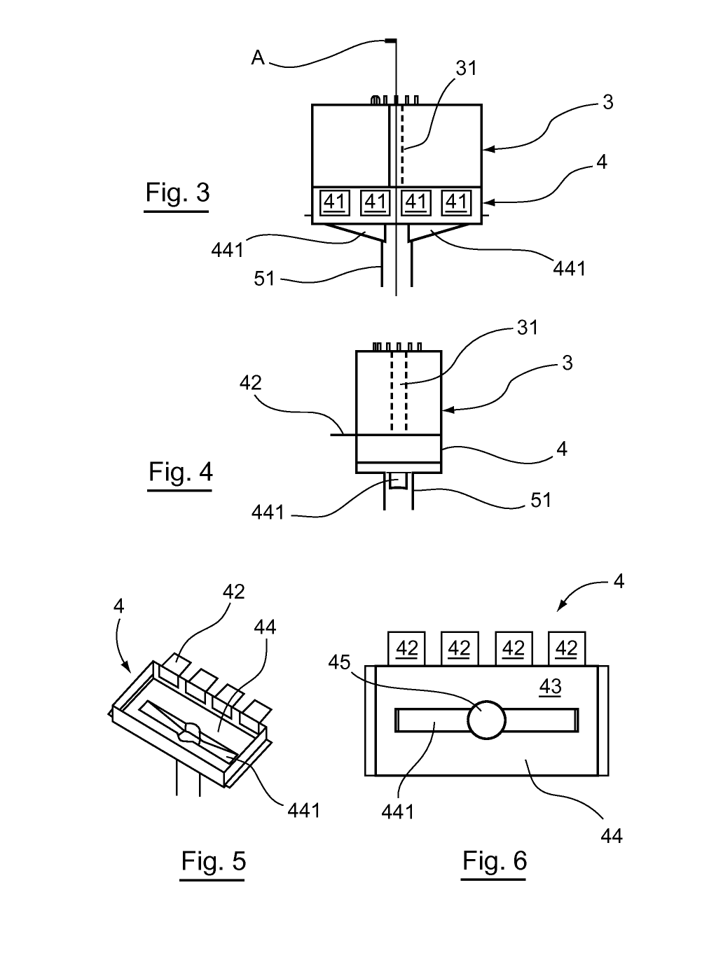

According to the invention, the guide bar 6 is positioned along the central axis of gravity of the device. Referring to FIG. 3, the float 3 is provided to this end with a vertical central recess having a cross-section slightly greater than the section of the guide bar 6 and intended for receiving it.

Referring to FIGS. 5 and 6, the water removing unit associated with the floats 3 comprises a chamber 44 for speeding up the clarified water that is to enter the device for removing through the holes 41. The bottom 43 of this chamber 44 is connected to the upper tube 51 of the means 5 for collecting removed water. This bottom 43 is also provided with inclined gullies 441. The incline of these gullies reduces the load loss undergone by the water entering the upper tube 51.

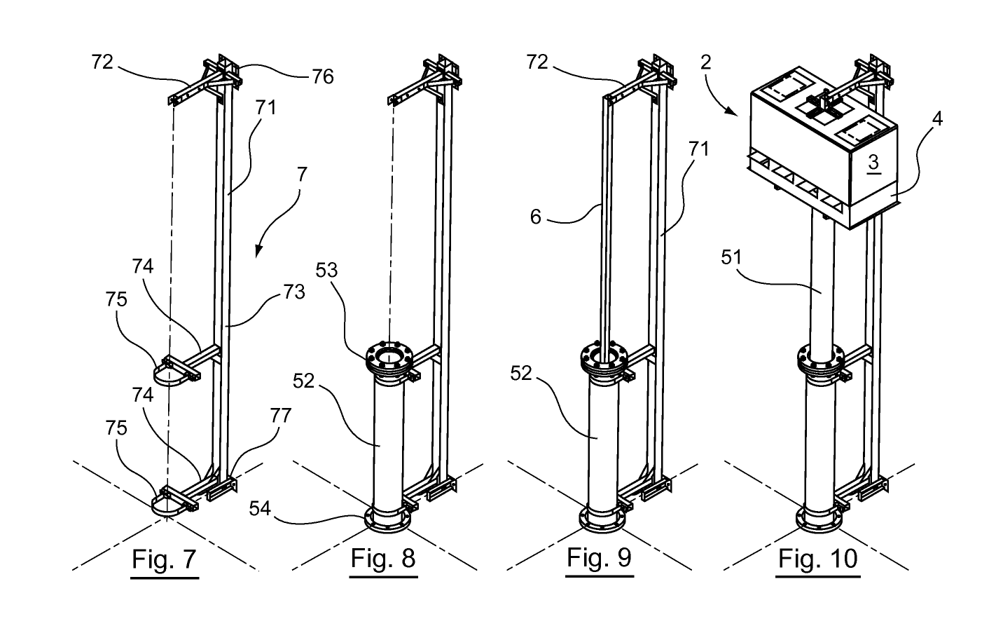

FIGS. 7 to 10 represent the in-factory pre-assembling of the different elements of the device before it is installed in a basin.

Initially, as indicated in FIG. 7, the means for support and fixed attachment 7, which are to be subsequently fixed to the wall of a basin, are constituted by assembling the vertical bar 73 and the horizontal bar 72 to form the bracket mount 71. Then, the upper fastening plate 76 and the lower fastening plate 77 are mounted on this bracket mount and the bar 74 and the collars 75 are put into position.

As indicated in FIG. 8, the lower tube 52 of the means for collecting the removed water 5 is joined with the bracket mount by means of the collars 75. A connecting flange 54 for connecting the lower tube 52 to a water outlet conduit of the basin is provided at its base and a tightly-sealed connector 53 making it possible to set up tight sealing with the upper tube of the means for collecting 5 is then fixedly attached to the upper end of the tube 52.

Referring to FIG. 9, the vertical guide bar 6 of the float is then slid inside the tube 52 and its upper end is fixedly attached to the end of the horizontal part 72 of the bracket mount 71 while its lower end is left free, at the upper end of the lower tube 52.

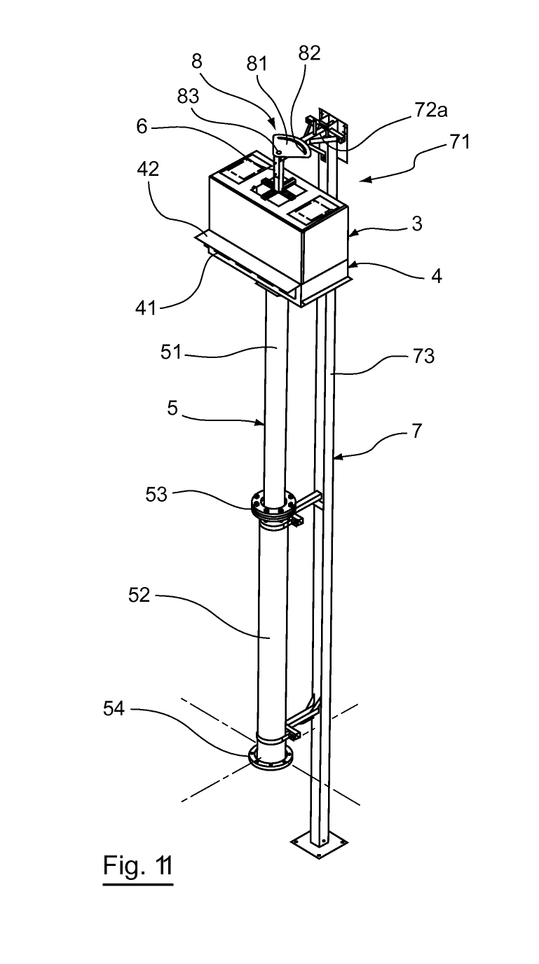

The assembly constituted by the float 3 equipped with the removing unit 4 and the upper tube 55 can then be installed as indicated in FIG. 10.

Referring to FIG. 2, once installed in the basin, the device described can be implemented at the end of a settling phase of a water treatment process in SBR mode in order to discharge the clarified water on the surface. To this end, the dimensions of the float are planned in such a way that the holes 41 of the unit for removing 4 are permanently submerged just beneath the surface of the water.

The clarified water is removed by the unit 4 and transits through the chamber 44 of this unit before being directed towards the means for collecting 5 in order to be discharged. As and when it is discharged from the basin, the level of this water therein drops. Owing to the telescopic nature of the means for collecting 5, the float 3 equipped with the unit for removing 4 and the tube 51 constituting a mobile part of the device get lowered with this level in the basin in following the axis defined by the guide bar 6. The lowering can be continued up to a minimum level according to which the upper tube 51 completely enters the lower tube 52.

Because of the central guide bar 6 planned along the axis of gravity of the device, there is practically no risk of the float 3 getting jammed in this bar. This bar 6 besides does not pick up the vertical/axial forces exerted on this float 3 and on this removing unit 4, since this float and this unit slide around this bar. This bar 6 besides picks up the horizontal/radial forces exerted on this float 3 and on this removing unit 4. All these forces are then transmitted to the support and fixed attachment means 7 constituted by the bracket mount 71 by means of its horizontal part 72 and linking bars 74.

The device according to the invention is thus simple to install. In addition, the mobile part constituted by the float 3, the removing unit 4 and the upper tube 51 of the means for collecting 5 constitute a mobile part which can easily be disconnected from the fixed part constituted by the lower tube 52 and the support and fixed attachment means 7 fixed to the wall of the basin. Thus, it is possible to change this mobile part if needed without having to dismantle the totality of the device fixed to the basin. It is also possible to dismantle this mobile part to carry out the maintenance of the float and the removing unit if need be.

Referring to FIGS. 11 to 14, a second embodiment of a device for removing clarified water according to the present invention shall now be described. In these figures, the elements common to the first embodiment have the same references.

According to this second embodiment, the holes 41 of the removing unit 4 are surmounted by a common baffle 42.

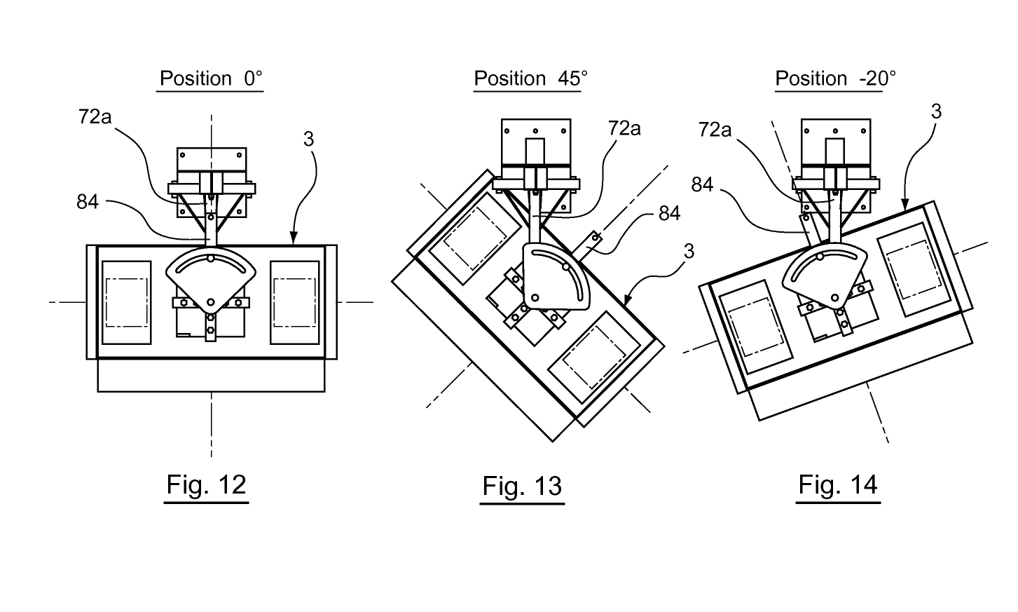

Besides, according to this second embodiment, the horizontal part 72a of the bracket mount 71 has one end that is not directly connected to the guide bar 6 but by means of a unit 8 constituting a means of pivoting of the float 3. This unit 8 is constituted by a plate having the shape of a disk sector 81 having a pivoting shaft 83 and a guiding aperture in the form of an arc of a circle 82. This pivoting shaft 83 is connected to the upper end of the guide bar 6 while the horizontal part 72a of the bracket mount 71 has an end, which is designed to slide in the guiding aperture with the shape an arc of a circle 82 of the plate 81. This plate 81 is furthermore extended by a rod 84, the actuation of which, referring to FIGS. 12 to 14, orients the float 3 in an angular amplitude corresponding to that of the aperture shaped like an arc of a circle 82.

Such an orientation of this float 3 makes it possible to adapt its position to different basin configurations, especially to prevent the taking up of floating matter or of subnatants, which may get concentrated in certain parts of the basin according to the configuration.

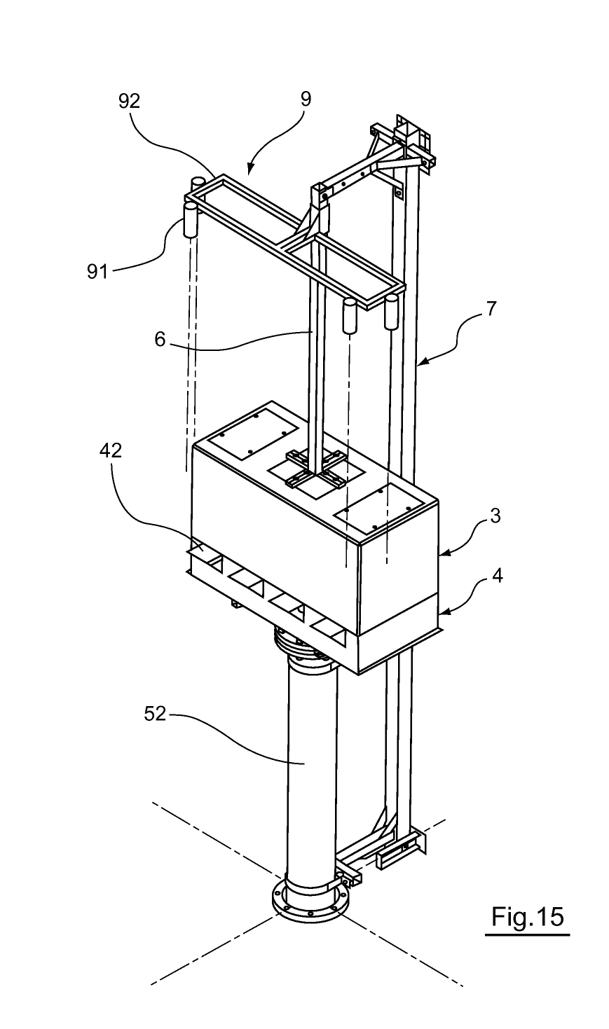

Referring to FIG. 15, a third embodiment of the device for removing clarified water according to the invention is described. In this figure, the elements common to the first and/or second embodiment have the same reference.

It can be noted that, in FIG. 15, this third embodiment is represented with the float 3 provided with the removing unit 4 at its lowest possible level in the basin, the upper tube 51 of the means for collecting removed water having completely entered the lower tube 52 of these same means.

In this third embodiment, the device is equipped with a support 9 supporting the probes 91. More specifically, the support 9 is constituted by a frame 92 mounted so as to be sliding on the central guide bar 6 so that it can adapt to at least two positions, namely:
a first position in which the frame 92 rests on the baffles 42 equipping the removing unit 4, and
a second position as shown in FIG. 15 in which the frame 92 is raised independently of the float 3 so that the probe 91 can be easily retrieved by an operator.

Such a probe support, capable of being raised independently of the float, has a non-negligible advantage as compared with the prior art in which, to measure the parameters of the clarified water collected by the removing unit of the float, it is necessary to resort to the use of lengthy canes that are cumbersome to handle and do not always make it possible to collect water at the same distance from the float.

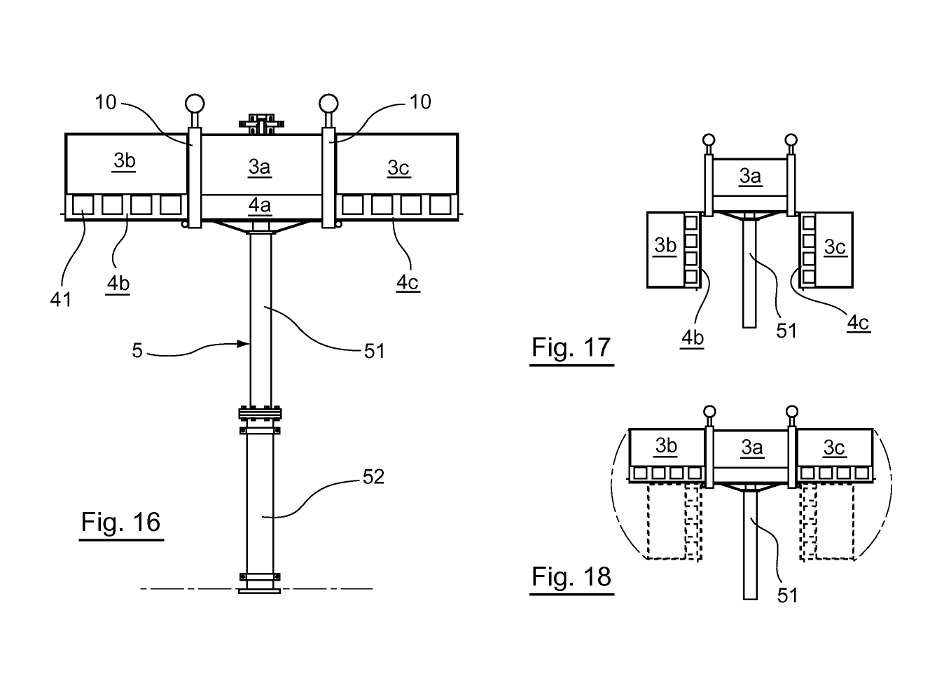

Referring to FIGS. 16 to 18, a fourth embodiment of the device for removing clarified water according to the invention is described, this embodiment being intended for the treatment of high flow rates of clarified water.

According to this embodiment, the float consists of three parts, 3a, 3b, 3c namely a central part 3a connected to two side parts 3b and 3c. The removing unit 4 is for its part also constituted by three parts 4a, 4b and 4c. Only the parts 4b and 4c are provided with water inlet holes 41.

According to this fourth embodiment, two valves 10 are provided to open or close access to water travelling through the holes 41 towards the central part 4a of the removing unit in order to be discharged by the means for collecting 5. Depending on the flow rate of discharging desired, one or two thrusters can be actuated to double or not double the quantity of clarified water travelling through the device.

As will be understood with reference to FIGS. 17 and 18, the parts 3b and 3c of the float equipped with the corresponding parts 4b and 4c of the removing unit are mounted so as to be pivoting on the part 3a of the float, so that they can be folded towards the tube 51. The assembly constituted by the float, the removing unit and the upper tube 51 can thus be transported or stored in a limited volume.

It will be noted that, in the four embodiments described, the water inlet holes are provided on only one face of the removing unit. However, depending on the basin configurations, it can be planned to provide two, three or four faces of the removing unit with such holes.

1-12. (canceled)

13. Device for removing clarified water that is to equip a basin, said device comprising:
at least one float mobile in vertical translation provided with at least one water removing unit;
means for collecting and discharging the removed water;
means for guiding said mobile float in vertical translation;
means attached to said basin for supporting the device;
characterized in that said device comprises a central vertical guide bar disposed along a central axis of gravity of the device, said guide bar passing through said float and extending into said means for collecting and discharging.

14. Device according to claim 13 characterized in that said means for collecting and discharging are telescopic and comprise an upper tube connected to said water removing unit and a lower tube.

15. Device according to claim 13 characterized in that said means of support and fixed attachment to the basin include a bracket mount, the horizontal part of which is connected to said guide bar and the vertical part of which is to be fixed to the wall of said basin.

16. Device according to claim 14 characterized in that said means of support and fixed attachment include at least one linking bar connecting said vertical part of said bracket mount to said lower tube of said means for collecting and discharging.

17. Device according to claim 13 characterized in that said water removing unit is constituted by a chamber provided beneath said mobile float, said chamber having water inlet holes distributed throughout or on a part of its rim and intended to be submerged.

18. Device according to claim 17 characterized in that said water inlet holes are surmounted by baffles.

19. Device according to claim 17 characterized in that said chamber has a bottom connected to said means for collecting and discharging and provided with gullies tilted towards said means for collecting and discharging.

20. Device according to claim 13 characterized in that said float and said removing unit form an essentially parallel pipe-shaped assembly, said float being provided with a vertical central channel receiving said guide bar.

21. Device according to claim 13 characterized in that it comprises means for pivoting said float in a horizontal plane.

22. Device according to claim 13 characterized in that it comprises a probe support mounted so as to be sliding on said horizontal bar and capable of being raised independently of said float.

23. Device according to claim 13 characterized in that said float is formed by three parts, namely a central part and two lateral parts connected to said central part and planned to be on either of its sides, each of said parts being equipped with a corresponding part of the clarified water removing unit, and in that said device furthermore includes two valves for controlling said water removing unit.

24. Device according to claim 23 characterized in that said lateral parts of said float are mounted so as to be pivoting on said central part.

25. A device for removing clarified water from a basin comprising:
(a) a float;
(b) a water removing unit associated with the float and moveable up and down with the float;
(c) a telescoping pipe assembly connected to the water receiving unit for receiving water from the water receiving unit and directing the water to an outlet;
(d) a support structure adapted to be secured in the basin; and
(e) a guide bar secured to the support structure and extending through the float and through at least a portion of the telescoping pipe assembly for guiding the float as the float moves up and down in response to the height of the water level changing in the basin.

26. The device of claim 25 wherein the float includes a center of gravity and wherein the guide bar extends through the center of gravity of the float.

27. The device of claim 25 wherein the telescoping pipe assembly includes upper and lower pipes wherein one pipe is telescopically contained within the other pipe and wherein at least one of the pipes is connected to the water receiving unit.

28. The device of claim 25 wherein the support structure includes a vertical member configured to be secured to a wall of the basin and wherein the support structure further includes a horizontal member that projects from the vertical member and which is operatively connected to the guide bar.

29. The device of claim 28 including one or more linking bars interconnecting the vertical member of the support structure with the telescoping pipe assembly.

30. The device of claim 25 wherein the water receiving unit is connected to a bottom portion of the float; wherein the water receiving unit includes a chamber disposed below the float for receiving and holding water; and wherein the chamber includes one or more openings through which water passes from the basin into the chamber.

31. The device of claim 30 wherein the opening of the water receiving unit includes a baffle surrounding at least a portion of the opening.

32. The device of claim 30 wherein the chamber includes a bottom having an opening therein wherein the opening in the bottom of the chamber is connected to an upper pipe that forms a part of the pipe assembly.

33. The device of claim 32 wherein there is provided one or more gullies formed in the bottom of the chamber of the water receiving unit and wherein the one or more gullies are operative to channel water in the chamber to the opening formed in the bottom of the chamber.

34. The device of claim 25 wherein the float and water receiving unit form a generally parallel piped-shaped assembly and wherein the float is provided with a vertical channel for receiving the guide bar.

35. The device of claim 25 wherein the support structure is configured to permit the float to pivot about a vertical axis.

36. The device of claim 25 wherein the float is formed by three parts including a central and two lateral parts and wherein each part of the float is connected to a part of the water removing unit.

37. The device of claim 25 wherein the float includes a center of gravity and wherein the guide bar extends through the center of gravity of the float; and wherein the telescoping pipe assembly includes an upper pipe and a lower pipe and wherein one of the pipes is telescopically contained in the other pipe.
